(19) United States
(12) Patent Application Publication
(10) Pub. No.: US 2003/0055823 A1
(43) Pub. Date: Mar. 20, 2003

(54) System for managing information registered in a plurality of locations and a method thereof

(75) Inventor: Toshiro Shibanuma, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/101,358

(22) Filed: Mar. 20, 2002

(30) Foreign Application Priority Data
Sep. 20, 2001 (JP) 2001-286733

(51) Int. Cl. G06F 7/00

(52) U.S. Cl. 707/7

(57) ABSTRACT

A plurality of pieces of information registered in a plurality of different registration locations are simultaneously sorted in order of registration, and the sorted results are displayed on a same screen.

### BACKGROUND OF THE INVENTION

1. Field of the Invention

The present invention relates to a method of managing information using a computer and more particularly to a system for managing information registered in a plurality of registration locations, and a method thereof.

2. Description of the Related Art

Some pieces of groupware are provided with a document management function for enabling a plurality of users (members) to share information (document, file, etc.). For the facilitation of a document management process, the groupware prepares a plurality of folders and assigns information to the folders based on the category and type of information to be registered. Therefore, such a folder management process enables information to be classified based on the category and type, thereby arranging information efficiently.

Further, a folder management function of information is installed not only in groupware but also in a network file sharing system using a network, a word processor, a filer operating on a file system, e-mail software, and the like.

The above-mentioned conventional folder management function, however, has the following problems.

In folder management where a plurality of members share information using a network, many members do not become aware of new information in many cases, even if other members have newly registered information. Thereupon, each member has to access each folder frequently, and check the contents to determine whether information has been newly registered.

A registrant can notify the other members of a fact that information has been newly registered, so that each member does not need to perform the above-mentioned operation, which is troublesome for the registrant. Furthermore, it is also be conceivable that the registrant will forget to send the notice to the other members.

Today, since the number of categories of information to be organized has increased, the number of folders to be used for management of the information has also increased. Therefore, it is difficult for even a registrant to determine the folder in which the information has been registered. Newly registered information has an especially high possibility to be used for future work. Accordingly, if it is difficult to determine the newly registered information, this becomes an obstruction to the work.

### SUMMARY OF THE INVENTION

The subject of the present invention is to provide a system for easily determine whether information is newly registered in an information management system having a plurality of different registration locations, such as a folder management function, and a method threreof.

The information management system of the present invention is provided with a sorting device and a preparation device, and manages information registered in a plurality of different registration locations. The sorting device simultaneously sorts information registered in a plurality of different registration locations in order of registration. The preparation device prepares data for displaying the sort results on the same screen.

### BRIEF DESCRIPTION OF THE DRAWINGS

FIG. 1 is a block diagram showing the principle of an information management system of the present invention;

FIG. 2 is a block diagram showing the structure of the first information management system;

FIG. 3 is a table showing the folder structure of document management;

FIG. 4 is a table showing folder management information;

FIG. 5 is a flowchart of the first display process;

FIG. 6 is a top page of groupware.

FIG. 7 is a flowchart of the second display process;

FIG. 8 is a flowchart of the third display process;

FIG. 9 is a block diagram showing the structure of the second information management system;

FIG. 10 is a table showing server management information;

FIG. 11 is a flowchart of the fourth display process;

FIG. 12 is the flowchart of a format unification process;

FIG. 13 is a block diagram showing the structure of an information data processing device; and

FIG. 14 is the block diagram showing a recording medium.

### DESCRIPTION OF THE PREFERRED EMBODIMENTS

The following is a detailed explanation of the preferred embodiments of the present invention with reference to the drawings.

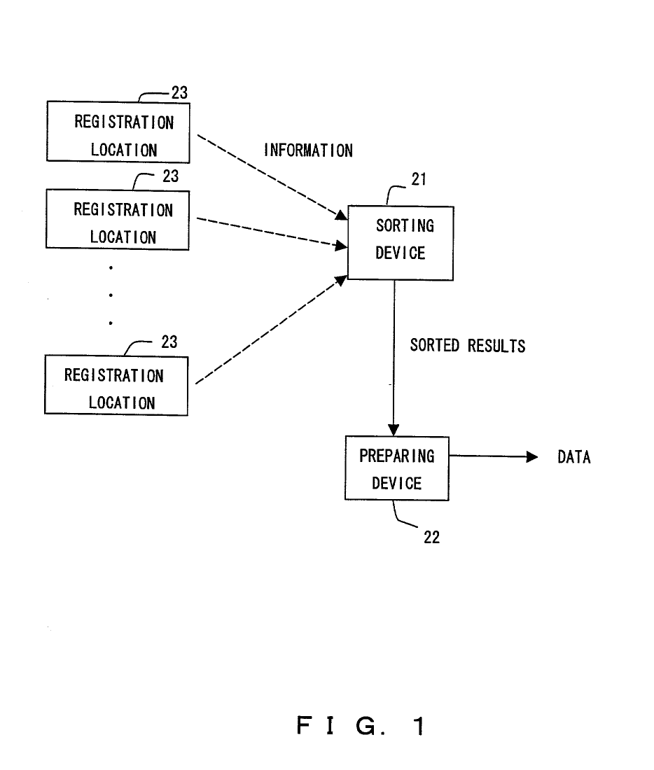

FIG. 1 is a block diagram showing the principle of an information management system of the present invention. The information management system of FIG. 1 is provided with a sorting device 21 and a preparation device 22, and manages a plurality of pieces of information that are registered in a plurality of different registration locations 23. The sorting device 21 simultaneously sorts a plurality of pieces of information that are registered in a plurality of registration locations 23 in order of registration. The preparation device 22 prepares data for displaying the sorted results on the same screen.

Such an information management system is constructed by, for example, a computer and its program. In this case, the program simultaneously sorts all pieces of information that are registered in a plurality of registration locations 23 in order of registration, and causes a computer to execute the process of preparing data for displaying the sorted results on the same screen. In this way, a display process is executed based on the thus-prepared data on the computer or on another computer.

The plurality of registration locations 23 correspond to a plurality of folders used for folder management and a plurality of devices or the like on a communication network, and they are respectively put under different management controls. A plurality of pieces of information that are registered in these registration locations 23 are simultaneously sorted by the sorting device 21, and sorted results in which all the pieces of sorted information are arranged in order of registration are prepared. Then, data for displaying the sorted results is prepared by the preparation device 22, and the prepared data is transferred to an indicator or the terminal device (client) of a user, which is provided in the system. In this way, the sorted results are displayed on the same screen.

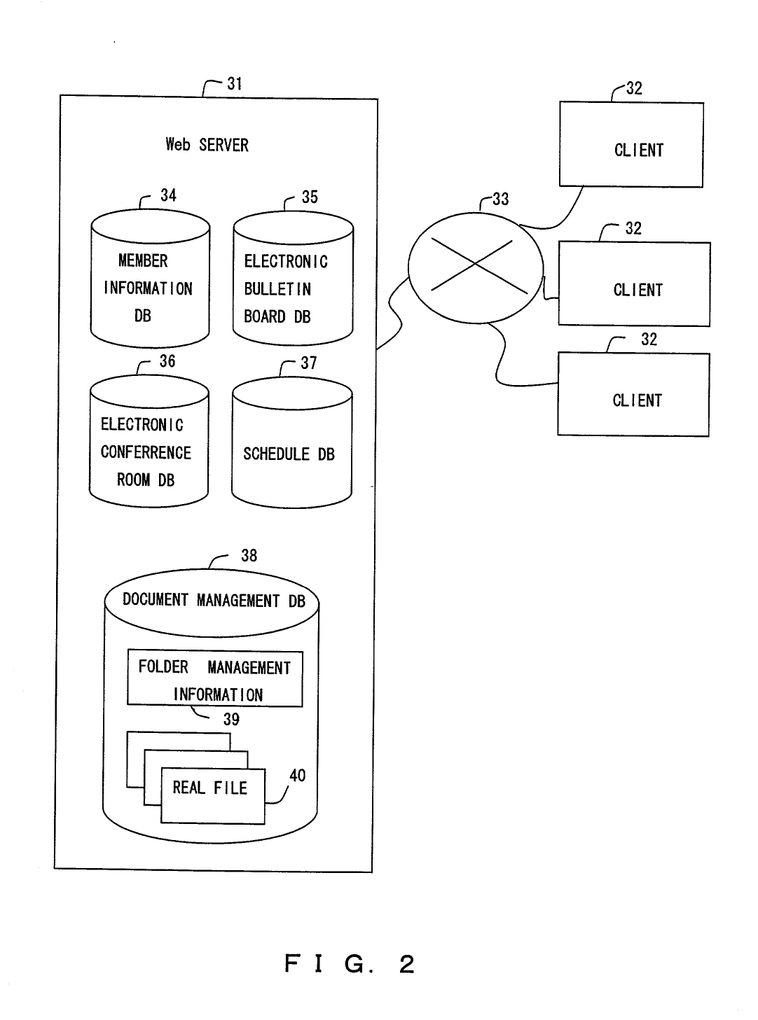

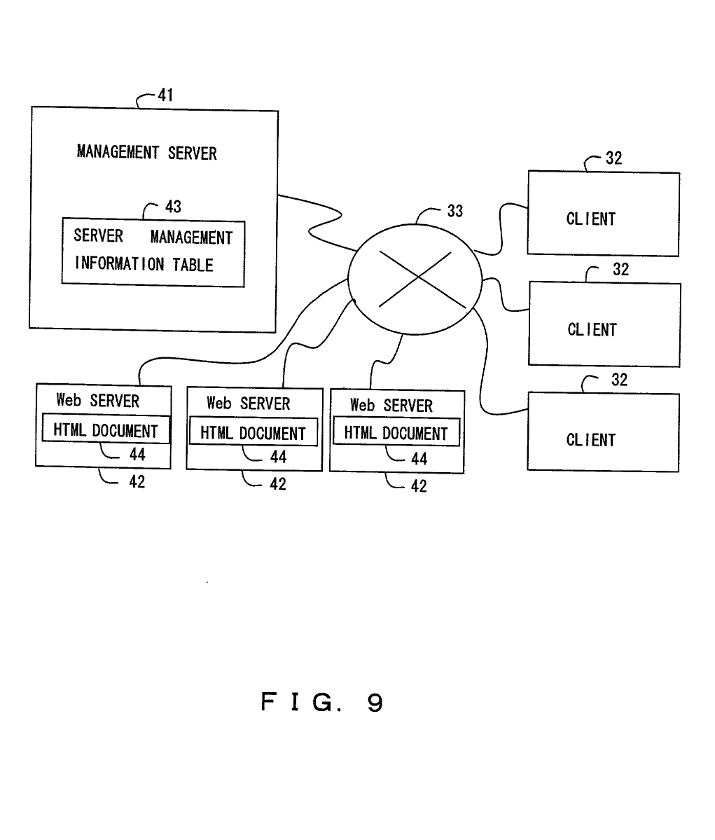

According to the above-mentioned information management system, a user can simultaneously view all the pieces of information registered in a plurality of registration locations 23, on the same screen. Therefore, a user can easily determine whether information is newly registered. The sorting device 21 and the preparation device 22 of FIG. 1 correspond to, for example, a Web server 31 of FIG. 2 or a management server 41 of FIG. 9, which are described later.

In the present preferred embodiments, a plurality of pieces of information, which are registered in a plurality of different registration locations are all displayed on the same page (same screen) in real time. At this time, only the information that is newly registered can be displayed on the same page, or all the pieces of information are sorted in order of registration, thereby displaying a list of the sorted results. Further, even the information concerning the registration location of information (folder information, device information or the like) can also be displayed.

FIG. 2 is a block diagram showing the structure of an information management system of the present preferred embodiment. The information management system of FIG. 2 is provided with the Web server 31 for realizing a groupware function and a plurality of clients 32 to be used by a plurality of members, which are connected by a communication network 33 such as a LAN (Local Area Network), the Internet, or the like.

The Web server 31 is provided with a groupware program, other than a program for realizing the function of a general Web server, and it receives a page arrangement request, or a document registration/elimination request from the client 32. Further, the Web server 31 is provided with various kinds of databases such as a member information DB 34, an electronic bulletin board DB 35, an electronic conference room DB 36, a schedule DB 37, a document management DB 38, etc., to develop a groupware function.

Concerning the electronic bulletin board DB 35, for example, a plurality of electronic bulletin boards and each article that is written in each of the electronic bulletin boards, are managed in folders. Concerning the electronic conference room DB 36, a plurality of electronic conference rooms, the subjects, and the written comments can be managed in folders.

The document management DB 38 manages information in the folder of a hierarchy structure, and stores folder management information 39 (which is also called path information) and a real file 40. Each real file 40 corresponds to the information that is registered in each folder, while a file name of the real file 40 corresponds to a title of the registered information.

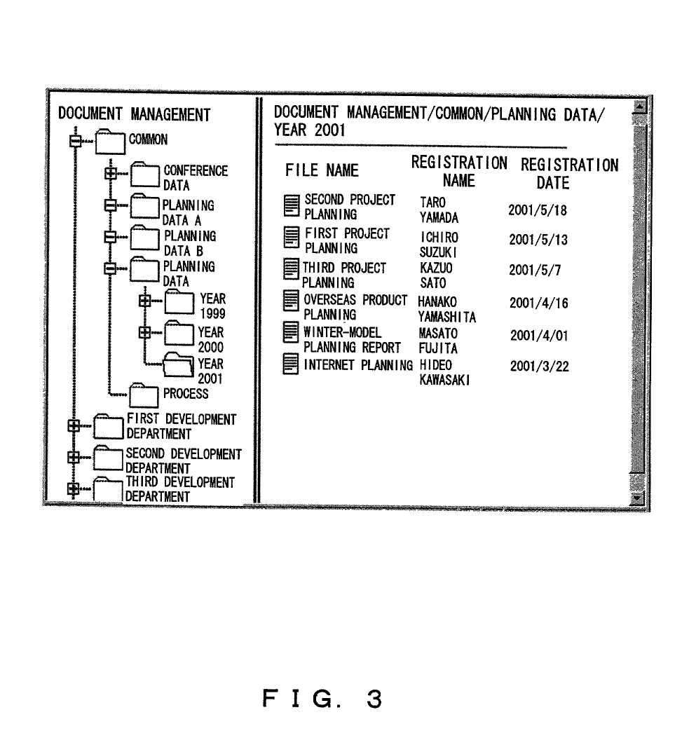

In this case, the information of a folder structure and the list of each file (file name) inside an open folder (here, “year of 2001”) are displayed on the page of document management, as shown in FIG. 3. In the folder structure of FIG. 3, a folder is prepared for each department of an organization (first development department, etc.), and the common folder stores a file common to the respective departments.

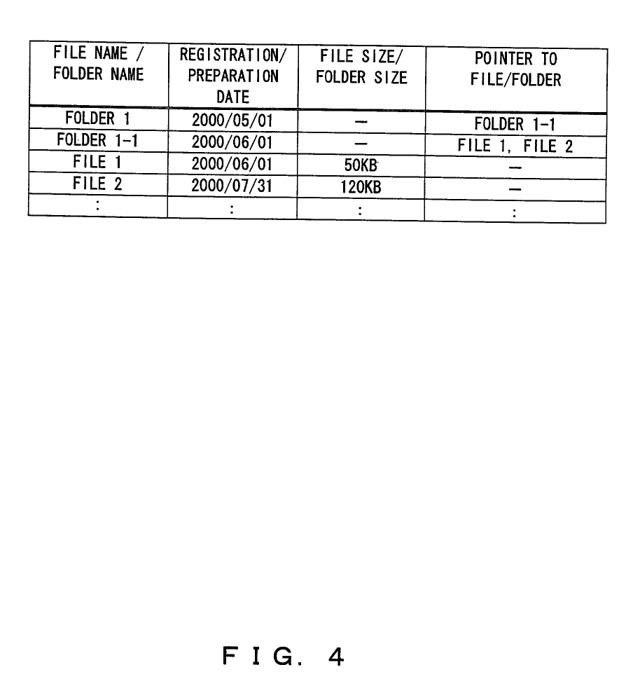

The folder management information 39 consists of the respective pieces of information, such as a file name/folder name, a registration/preparation date, a file size/folder size, and the pointer to a file/folder, as shown in FIG. 4. Here, a registration/preparation date represents the date and time that a folder is prepared or a file is registered. The file size represents the size of a file, while the pointer shows an address on a disk where the folder or the real file of a lower hierarchy is present.

The same folder management can be performed for the electronic bulletin board DB 35 and the electronic conference room DB 36.

A Web browser is installed in each client 32, and information is sent/received by HTTP (Hyper Text Transfer Protocol) between the Web server 31 and the client 32. Each member registers or browses the information that is managed by groupware, using this Web browser.

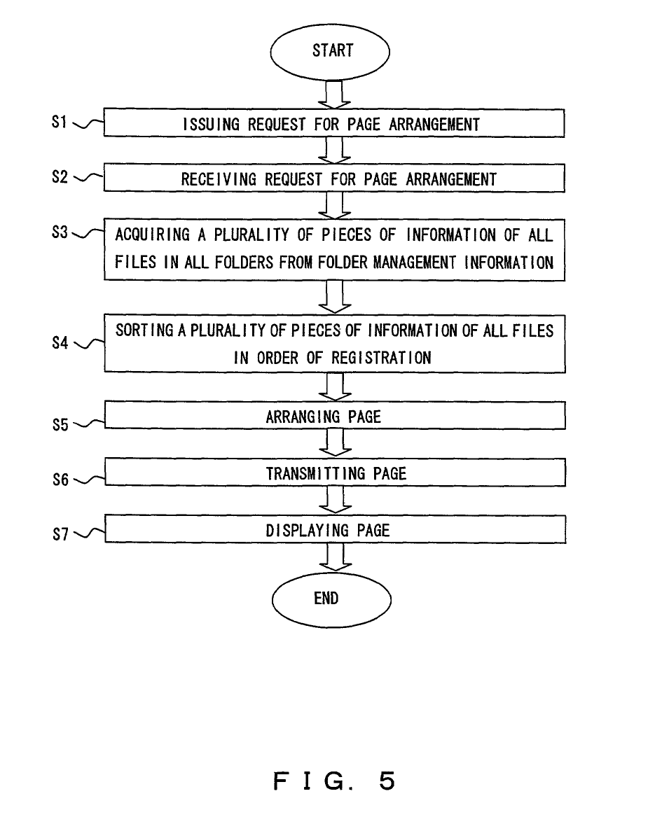

FIG. 5 is a flowchart of a process of displaying the information managed by the Web server 31 on a browser screen of the client 32 in such a system.

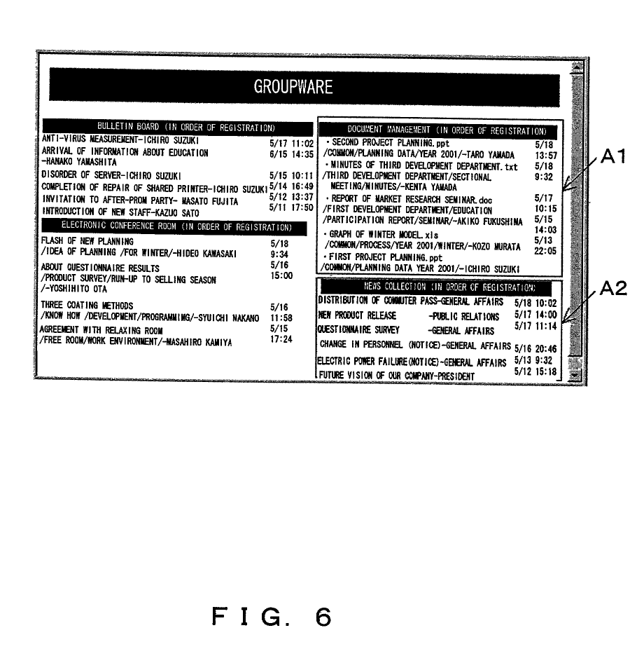

First, a user of the client 32 issues to the Web server 31 a page arrangement request for the display of a specified page like the top page of groupware or the page of document management (step S1). The top page of groupware is configured to display the latest various pieces of information that are registered in an electronic bulletin board, an electronic conference room, document management, or the like, on the same page as shown in FIG. 6. On the page of document management, the folder structure in document management and a list of the registered files are displayed as shown in FIG. 3.

Next, the Web server 31 receives the request for page arrangement (step S2), and acquires from each database the information to be displayed on the page. In the case that the file registered in document management is displayed, for example, the Web server 31 accesses the document management DB 38, and acquires a plurality of pieces of information that are registered in all the folders, from the folder management information 39 (step S3).

Next, a plurality of pieces of the acquired information are merged to be sorted in order from the most recent date among the dates included in the plurality of pieces of the information (step S4). Next, a plurality of pieces of information of files of which the number (predetermined number) has been determined in advance from the top of the sorted results, are selected as page configuration information, thereby preparing a page (step S5). Then, the prepared page is transmitted to the client 32 (step S6).

The client 32 displays the received page on a browser screen (step S7). In the case of a top page of the groupware shown in FIG. 6, the sorted pieces of information of the files are displayed in a range A1 of document management. The file name, the folder information that shows the path of the folder, the name of an owner (registrant) of the file, and the registration date are displayed in the range A1, in order from the most recent date. Further, the link to a real file (detailed contents of information) can also be added for display.

Since all the pieces of information that are newly registered in the respective folders are simultaneously displayed in the same range on the same page based on such a display process, a user can easily determine whether information is newly registered. Therefore, a process of accessing each folder and retrieving the registered information is not required anymore, thereby avoiding a disadvantage that a user does not notice that the other members have newly registered information.

A plurality of pieces of the newly-registered information of a predetermined number are displayed, thereby preventing browsing leakage, which occurs when necessary information cannot be found because too many pieces of information are displayed, and also eliminating the need for searching information piece by piece. Since a plurality of pieces of information are sorted in order of registration to be displayed, a user can easily determine which is older information or newer information among the displayed pieces of information.

Furthermore, since the information concerning a registration location of information is also displayed, a user can determine the category of the newly registered information at the same time, so that he or she can quickly access the file contents by linking a real file.

In the display process of FIG. 5, a user of the client 32 manually issues instructions concerning the issuance of a page arrangement request to the Web server 31. This request, however, can be automatically instructed by triggering a timer.

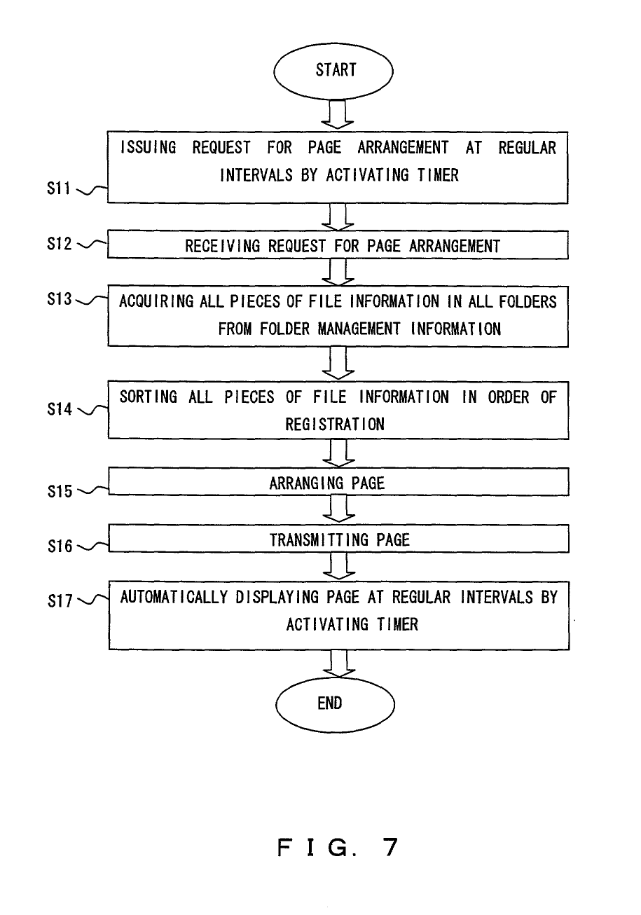

FIG. 7 is a flowchart of such a display process. In FIG. 7, the processes of steps S12 to S16 are fundamentally similar to those of steps S2 to S6 of FIG. 5. At step S11, the client 32 issues a page arrangement request at regular intervals using a timer provided inside the client 32. At step S17, the page received by the client 32 is automatically displayed.

In this way, the page as shown in FIG. 6 is automatically displayed at regular intervals. According to such a display process, a user can receive a list of newly-registered files at regular intervals, without issuing a request for page arrangement.

In a display process of FIG. 5, a page is transmitted only once from the Web server 31 to the client 32 concerning a page arrangement request to the Web server 31. However, a page can automatically be arranged to be transmitted again.

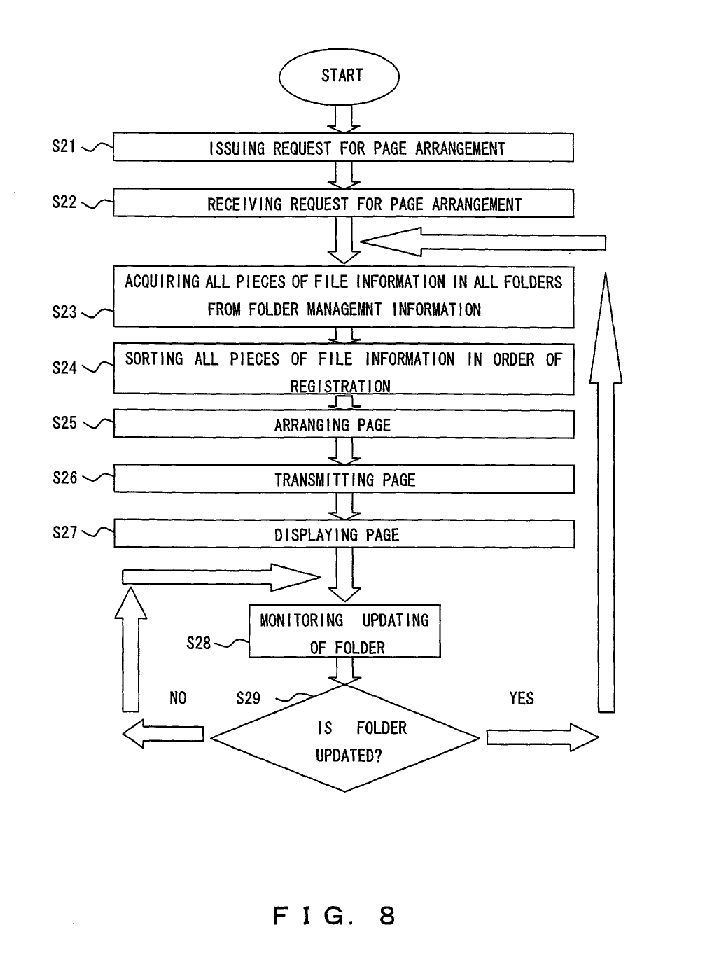

FIG. 8 is the flowchart of such a display process. In FIG. 8, the processes of steps S21 to S25 and that of step S27 are fundamentally similar to the processes of steps S1 to S5 and that of step S7 of FIG. 5. After transmitting a page, the Web server 31 constantly monitors the updated condition of each folder by a loop process (step S28), and it checks whether a new file is registered in a folder (step S29).

If the updating of the registration of files or the like is detected, the processes at and after step S23 are repeated, and the page is rearranged to be transmitted to the client 32 again. At step S26, at this time, the rearranged page is transmitted by, for example, PUSH transmission. In the PUSH transmission, information is automatically transmitted from the Web server 31 to the client 32 by the predetermined setup. Such a display process enables a user to receive a list of newly registered files each time a folder is updated, by only issuing a page arrangement request once.

In the above-explained information management system, the registration information of a database that is managed by groupware, is processed, but the information managed by the Web server 31 can also be processed.

In this information management system, all the files are registered in one Web server, while in the information management system of a network configuration, files are dispersed by a plurality of Web servers to be registered. Thereupon, the following is an explanation of an information management system that uses a plurality of Web servers.

FIG. 9 is a block diagram showing the configuration of such an information management system. The information management system of FIG. 9 is provided with a management server 41 and Web servers 42 installed at a plurality of sites in addition to the clients 32 of FIG. 2. The management server 41 executes a groupware program, acquires information from the other Web servers 42 through the communication network 33, and transmits the acquired information to the clients 32. The management server 41 stores a server management information table 43 for managing the information of the Web servers 42, while each Web server 42 stores an HTML document 44.

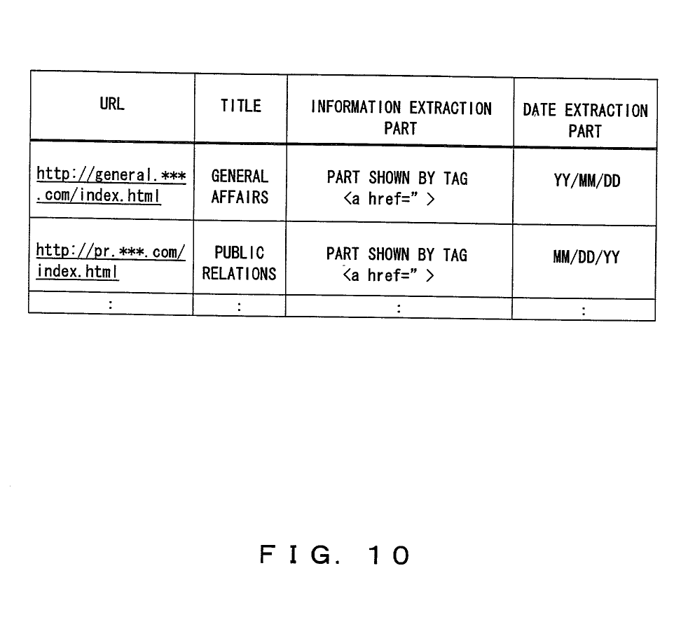

The server management information table 43 consists of pieces of information such as a URL (Uniform Resource Locator), a title, an information extraction location, and a date extraction location, as shown in FIG. 10. The URL is the address information that consists of a site address of the Web server 42 and the file name of an HTML document 44. In the HTML document 44, the configuration of a homepage of the site is described, while on this homepage, the information that is registered at the site is displayed together with the registration date.

The title suggests a site-specific title that is defined corresponding to a URL. In this example, a site is provided for each department of an organization (general affairs, etc.). The name of the corresponding department is used as the name of a site.

The information extraction part is the information that is used for a process of extracting the information to be displayed on a specified page (top page of groupware, etc.) from the HTML document 44. In this example, a display content part that is sandwiched between <a href=″″ > and </a> is defined to be extracted.

The date extraction part is information to be used for a process of specifying a date when the information source is registered, and the format of a date character string such as “YY/MM/DD”, “MM/DD/YY”, or the like is described. Here, YY, MM, and DD express two-digit numbers corresponding to a year, month, and day, respectively. In the display process of the above-specified page, the character string that is described in accordance with this format is extracted from the HTML document 44 as date information.

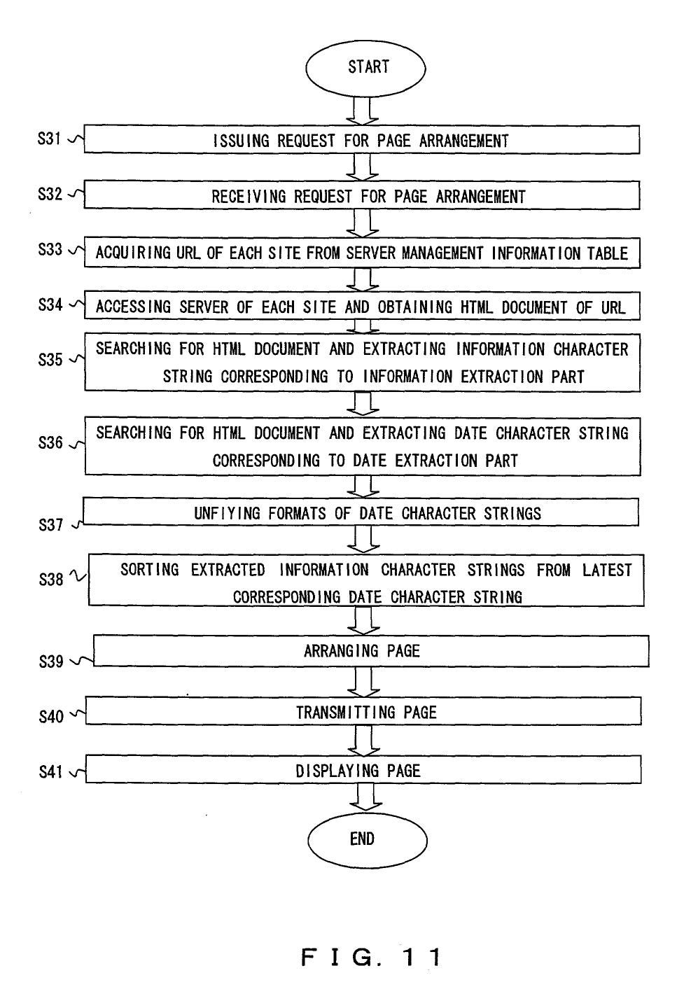

FIG. 11 is the flowchart of a process of displaying the information managed by the management server 41 on a browser screen of the client 32, in such a system.

Firstly, a user of the client 32 issues a page arrangement request to the management server 41, in order to display a specified page (step S31). This specified page corresponds to the top page of groupware or the like, and it includes a list of information sources registered in a plurality of Web servers 42 and links to the respective information sources.

Next, the management server 41 acquires a page arrangement request (step S32), refers to the server management information table 43, and obtains the URL of each registered site (step S33). Then, the server accesses the Web server 42 that is designated by the URL, and it acquires a file of the HTML document 44 that is designated by the URL (step S34).

Next, the server 41 searches for the acquired file, extracts an information character string of the part that is designated by an information extraction part of the server management information table 43 (step S35), and it extracts the date character string that is designated by a date extraction part of the server management information table 43 (step S36). In this way, a date that the information about the extracted information character string (information source where a link is established) is registered, is specified.

Next, formats of the date character strings that are extracted from the files of all the sites are unified (step S37), and all the extracted information character strings are merged to be sorted from the latest date (step S38). Next, the information character strings of a predetermined number are selected as page configuration information, thereby preparing a page (step S39). Then, the prepared page is transmitted to the client 32 (step S40).

The client 32 displays the received page on a browser screen (step S41). In the case of the top page of the groupware shown in FIG. 6, the extracted information character string, a title and a registration date that are defined in the server management information table 43 corresponding to the extraction source URL of the information character string, are displayed in order from the most recent date, in a range A2 of information collection. Furthermore, a link to the URL (detailed contents of the information) can also be added to be displayed.

According to such a display process, an effect similar to that of the system of FIG. 2 can be obtained, thereby eliminating the need for sequentially accessing each site and confirming information by a user at the same time. Further, a page can be automatically displayed in a fashion similar to the processes shown in FIGS. 7 and 8.

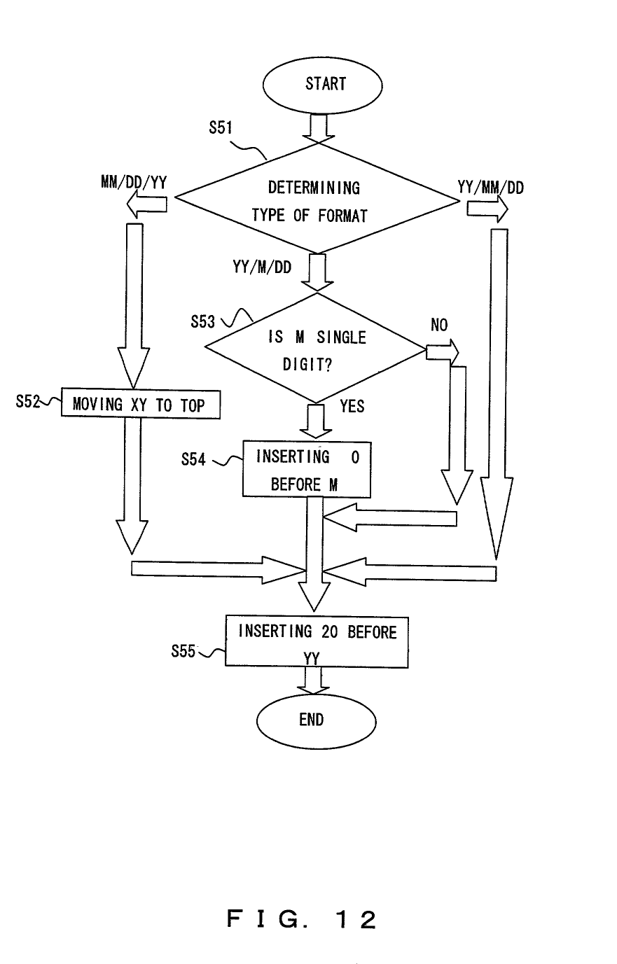

FIG. 12 is a flowchart of the process of unifying the formats of date character strings at step S37 of FIG. 11. At first, the management server 41 determines the format that is defined at the date extraction part of each site in reference to the server management information table 43 (step S51). Here, three types of formats such as “YY/MM/DD”, “MM/DD/YY”, and “YY/M/DD” are used. In the case of “YY/M/DD”, M indicates a single-digit number or a two-digit number.

If the format is “MM/DD/YY”, the management server 41 moves to the head a part equivalent to YY of the extracted date character string (step S52), and it inserts 20 before the part, in order to make the year four digits long (step S55).

Since it is the 2000s A.D. in this example, 20 is inserted. Similarly, in a case that 21 is inserted in the case of the 2100s A.D., and in a general sense, a number to be inserted can be changed according to the century A.D.

If the format is “YY/M/DD”, it is checked whether a number equivalent to M of the date character string is a single-digit number (step S53). If the number is a single-digital number, 0 is inserted before the number to make a number of the month a two-digit number (step S54), and a process at step S55 is performed. If the number is not a single-digit number, a process at step S55 is directly performed.

If the format is “YY/MM/DD”, a process at step S55 is directly performed. According to such a process, all the date character strings are unified into the format of “20YY/MM/DD”.

Meanwhile, real files of all the folders are stored in the same Web server in the information management system of FIG. 2, but a real file can be dispersed into a plurality of Web servers to be stored like the system of FIG. 9.

In the information management system of FIG. 2 and FIG. 9, the list of a plurality of pieces of information of a predetermined number selected from a plurality of pieces of the registered information is displayed. Like a process of displaying a plurality of pieces of information registered between the present date and three days ago, a plurality of information that are newly registered in a predetermined period is selected, and the list is prepared to be displayed. Since this process prevents the failure of browsing information, the need for searching for information can be eliminated. At the same time, this process further prevents a user from viewing the same information many times.

Furthermore, the present invention can be applied not only to groupware or a Web server but also to an optional system or an optional application, which is equipped with a folder management function like a word processor, a filer, e-mail software, or the like.

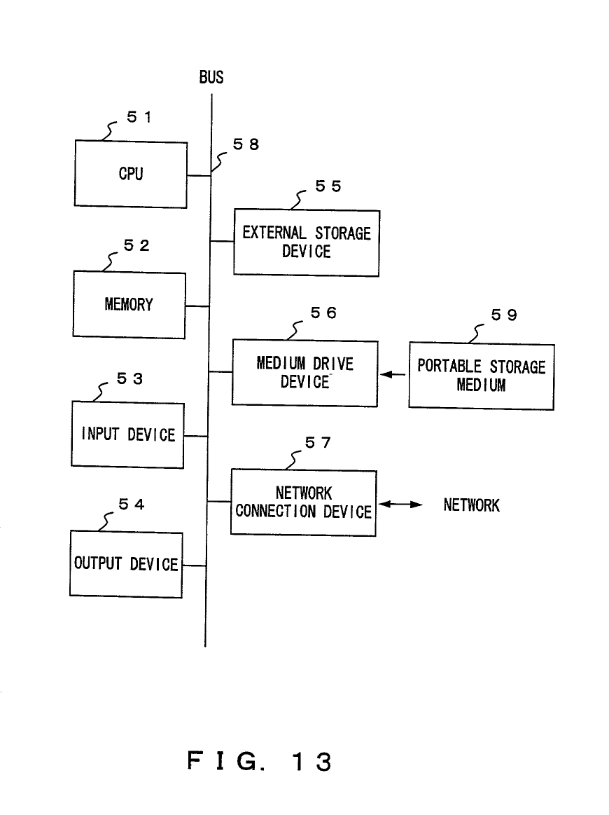

The Web server 31 and the client 32 of FIG. 2, and the management server 41 and the Web server 42 of FIG. 9 are configured by using, for example, an information processing device (computer) as shown in FIG. 13. The information processing device of FIG. 13 is provided with a CPU (central processing unit) 51, a memory 52, an input device 53, an output device 54, an external storage 55, a medium driving device 56, and a network connection device 57, which are connected by a bus 58.

The memory 52 includes, for example, ROM (Read Only Memory), RAM (Random Access Memory), etc., and stores programs and data to be used for processes. The CPU 51 performs required processes by implementing the stored programs using the memory 52.

The input device 53 is a keyboard, a pointing device, a touch panel or the like, and it is used for the input of instructions and information transmitted from an operator (manager of a server, user of a client, or the like). The output device 54 is a display, a printer, a speaker or the like, and is used for the output of the inquiry to an operator or process results.

The external storage 55 is, for example, a magnetic disk, an optical disk, a magnetic optical disk, a tape, or the like. The information processing device stores the above-mentioned program and data in the external storage 55. It uses them when needed after it loads them into the memory 52. The external storage 55 is also used as various databases of FIG. 2.

The medium drive device 56 drives a portable recording medium 59, and accesses the recorded contents. As the portable recording medium 59, an optional computer-readable recording medium such as a memory card, a flexible disk, a CD-ROM (Compact Disk Read Only Memory), an optical disk, a portable magnetic optical disc, or the like is used. An operator stores the above-mentioned program and data on the portable recording medium 59, loads them into the memory 52, and uses them when needed.

The network connection device 57 is connected to the communication network 33, and performs the data conversion, which is accompanied by communications. The information processing device receives the above-mentioned program and data from the other devices through the network connection device 57, loads them into the memory 52, and uses them when needed.

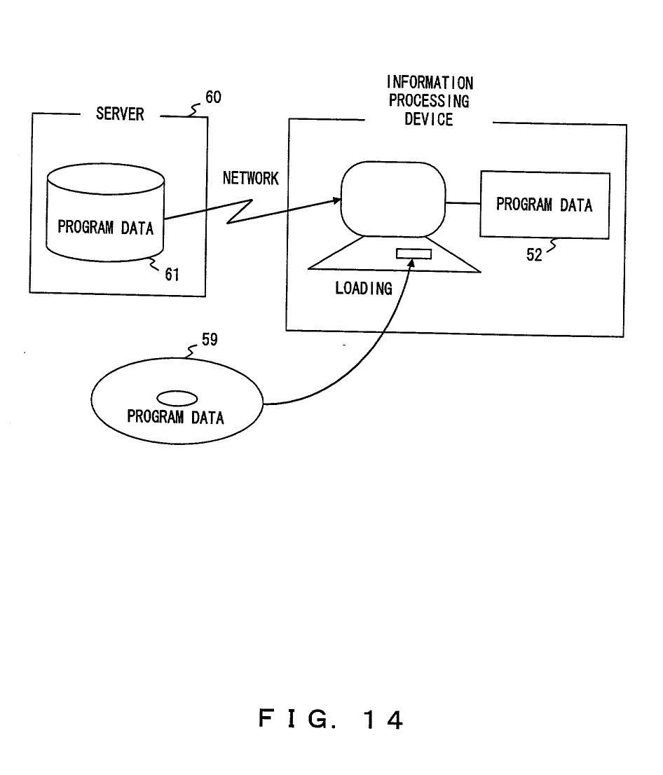

FIG. 14 shows a computer-readable recording medium for supplying a program and data to the information processing device of FIG. 13. The program and data that are stored in a database 61 of the portable recording medium 59 or a server 60 are loaded into the memory 52. At this time, the server 61 generates a conveyance signal for conveying the program and data, and transmits the signal to an information processing device through an optional transmission medium on a network. The CPU 51 implements the program using the data, and performs required processes.

According to the present invention, it is possible to easily determine whether newly-registered information is present, in an information management system with a plurality of different registration locations like a folder management function.

What is claimed is:

1. A computer-readable recording medium recording a program for a computer that manages a plurality of pieces of information registered in a plurality of different registration locations, said program causing the computer to perform:
collectively sorting the plurality of pieces of information registered in the plurality of registration locations in order of registration; and
generating data for displaying sorted results on a same screen.

2. The recording medium according to claim 1, wherein
the program causes the computer to perform selecting a plurality of pieces of new information of a predetermined number in order of registration and generating data for displaying the selected pieces of information on the same screen.

3. The recording medium according to claim 1, wherein
the program causes the computer to perform selecting a plurality of pieces of information registered in a predetermined period and generating data for displaying the selected pieces of information on the same screen.

4. The recording medium according to claim 1, wherein
the program causes the computer to perform generating data for displaying information about the registration locations of the registered pieces of information on the same screen.

5. The recording medium according to claim 1, wherein
the program causes the computer to perform generating data for displaying information about registrants of the registered pieces of information on the same screen.

6. The recording medium according to claim 1, wherein
the program causes the computer to perform generating data for displaying information about at least registration dates of the registered pieces of information on the same screen.

7. The recording medium according to claim 1, wherein
the program causes the computer to perform generating data for displaying links to detailed contents of the registered pieces of information on the same screen.

8. A computer-readable recording medium recording a program for a computer that manages a plurality of pieces of information registered in a plurality of different folders, the program causing the computer to perform:
collectively sorting the plurality of pieces of information registered in the plurality of folders in order of registration; and
generating data for displaying sorted results on a same screen.

9. A computer-readable recording medium for a computer connected with a plurality of devices through a communication network, the program causing the computer to perform:
acquiring a plurality of pieces of information registered in the plurality of devices through the communication network;
merging the acquired pieces of information and sorting in order of registration; and
generating data for displaying sorted results on a same screen.

10. A propagation signal propagating a program to a computer that manages a plurality of pieces of information registered in a plurality of different registration locations, the program causing the computer to perform:
collectively sorting the plurality of pieces of information registered in the plurality of registration locations in order of registration; and
generating data for displaying sorted results on a same screen.

11. A method of managing a plurality of pieces of information registered in a plurality of different registration locations, wherein:
a computer collectively sorts the plurality of pieces of information registered in the plurality of registration locations in order of registration; and
the computer generates data for displaying sorted results on a same screen of another computer.

12. An information managing system for managing information registered in a plurality of pieces of information registered in a plurality of different registration locations, comprising:
a sorting device collectively sorting the plurality of pieces of information registered in the plurality of registration locations in order of registration; and
a generating device generating data for displaying sorted results on a same screen.

13. The information managing system according to claim 12, wherein
the generating device selects a plurality of pieces of new information of a predetermined number in order of registration, and generates data for displaying the selected pieces of information on the same screen.

14. The information managing system according to claim 12, wherein
the generating device selects a plurality of pieces of information registered in a predetermined period, and generates data for displaying the selected pieces of information on the same screen.

15. The information managing system according to claim 12, wherein
the generating device generates data for displaying information about registration locations of the registered pieces of information on the same screen.

16. The information managing device according to claim 12, wherein
the generating device generates data for displaying information about registrants of the registered pieces of information on the same screen.

17. The information managing device according to claim 12, wherein
the generating device generates data for displaying information about at least registration dates of the registered pieces of information on the same screen.

18. The information managing system according to claim 12, wherein
the generating device generates data for displaying links to detailed contents of the registered pieces of information on the same screen.

19. An information managing system for managing a plurality of pieces of information registered in a plurality of different folders, comprising:
a sorting device collectively sorting the plurality of pieces of information registered in the plurality of folders in order of registration; and
a generating device generating data for displaying sorted results on a same screen.
